(19) United States
(12) Patent Application Publication
(10) Pub. No.: US 2024/0228705 A1
(43) Pub. Date: Jul. 11, 2024

(54) RESIN COMPOSITION

(71) Applicant: NAN YA PLASTICS CORPORATION, TAIPEI (TW)

(72) Inventors: Te-Chao Liao, TAIPEI (TW); Wei-Ru Huang, TAIPEI (TW); Hung-Yi Chang, TAIPEI (TW); Chia-Lin Liu, TAIPEI (TW)

(73) Assignee: NAN YA PLASTICS CORPORATION, TAIPEI (TW)

(21) Appl. No.: 18/171,299

(22) Filed: Feb. 17, 2023

(30) Foreign Application Priority Data
Dec. 23, 2022 (TW) 111149614

(51) Int. Cl. C08G 73/12; C08G 65/333; C08G 65/48; C08K 3/36; C08K 5/18; C08K 5/5425

(52) U.S. Cl. CPC C08G 73/12; C08G 65/33337; C08G 65/485; C08K 3/36; C08K 5/18; C08K 5/5425

(57) ABSTRACT

A resin composition is provided, which includes diamine, a BMI resin, and a modified polyphenylene ether resin having a following structural formula:

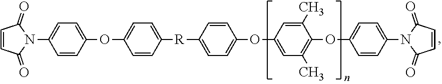

wherein R represents a chemical group of a bisphenol compound located between two hydroxyphenyl functional groups thereof, and n is an integer ranging from 3 to 25.

### CROSS-REFERENCE TO RELATED APPLICATION

This application claims the priority benefit of Taiwan application serial no. 111149614, filed on Dec. 23, 2022. The entirety of the above-mentioned patent application is hereby incorporated by reference herein and made a part of this specification.

### BACKGROUND

### Technical Field

The present disclosure relates to a resin composition.

### Description of Related Art

The resin composition based on the polyimide (PI) resin derived from diamine and BMI resin (bismaleimide) has advantages of high rigidity, low thermal expansion coefficient, and high glass transition temperature (Tg). It is widely used in different industrial fields, so how to improve the resin composition based on the polyimide system so that it can be competitive is an urgent goal for those skilled in the art.

### SUMMARY

The disclosure provides a resin composition, which effectively improves performance in terms of glass transition temperature, thermal expansion coefficient, peel strength, water absorption, heat resistance, dielectric constant and/or dielectric loss in polyimide-based systems, so the resin composition is competitive.

A resin composition of the disclosure includes diamine, a BMI resin, and a modified polyphenylene ether resin having a following structural formula:

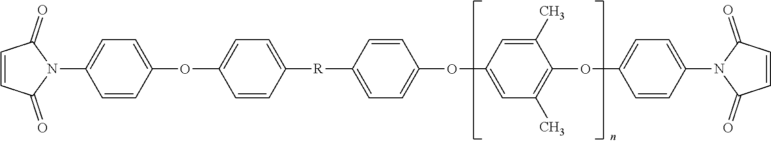

wherein R represents a chemical group of a bisphenol compound located between two hydroxyphenyl functional groups thereof, and n is an integer ranging from 3 to 25.

In an embodiment of the present disclosure, wherein a weight ratio range of the diamine is 20 wt % to 60 wt %.

In an embodiment of the present disclosure, wherein a weight ratio range of the modified polyphenylene ether resin is less than or equal to 80 wt %.

In an embodiment of the present disclosure, wherein the BMI resin is a polyphenylmethane maleimide resin, and a weight ratio range of the polyphenylmethane maleimide resin is 20 wt % to 60 wt %.

In an embodiment of the present disclosure, the resin composition further includes a catalyst, a flame retardant, silica, a siloxane coupling agent or a combination thereof.

In an embodiment of the present disclosure, a usage amount of the catalyst is 0.005 phr to 1 phr.

In an embodiment of the present disclosure, a usage amount of the flame retardant is 25 phr to 40 phr.

In an embodiment of the present disclosure, a weight ratio range of silica is 40 wt % to 70 wt %.

In an embodiment of the present disclosure, a usage amount of the siloxane coupling agent is 0.1 phr to 5 phr.

In an embodiment of the present disclosure, a dielectric constant of a circuit board made by the resin composition is 3.2 to 3.5, a dielectric loss is less than 0.0035, a glass transition temperature is greater than 280° C., a thermal expansion coefficient is less than 15 ppm/° C., a peel strength is greater than 4 lb/in and a water absorption is less than 0.4%.

Based on the above, in the resin composition based on polyimide system of the present disclosure, the diamine is combined as a cross-linking agent with the modified polyphenylene ether resin with specific structural formula. As a result, a good reactivity is generated through a functional group interaction between diamine and aforementioned modified polyphenylene ether resin, which effectively improve its performances of glass transition temperature, thermal expansion coefficient, peel strength, water absorption, heat resistance, dielectric constant and/or dielectric loss, so the resin composition can be competitive.

### DESCRIPTION OF THE EMBODIMENTS

Embodiments of the disclosure will be described in details below. However, these embodiments are illustrative, and the disclosure is not limited thereto.

Herein, a range indicated by “one value to another value” is a general representation which avoids enumerating all values in the range in the specification. Therefore, the description of a specific numerical range covers any numerical value within the numerical range and the smaller numerical range bounded by any numerical value within the numerical range, as if the arbitrary numerical value and the smaller numerical range are written in the specification.

In the present embodiment, a resin composition includes diamine(diamine), a BMI resin and a modified polyphenylene ether (PPE) resin having structural formula (1), wherein R represents a chemical group of a bisphenol compound located between two hydroxyphenyl functional groups thereof, and n is an integer ranging from 3 to 25. Accordingly, in the resin composition based on the polyimide system of the disclosures, the diamine is used as a cross-linking agent to combine with the modified polyphenylene ether resin with a specific structural formula. As a result, a good reactivity is generated through a functional group interaction between diamine and aforementioned modified polyphenylene ether resin, which effectively improve its performances of glass transition temperature, thermal expansion coefficient, peel strength, water absorption, heat resistance, dielectric constant and/or dielectric loss, so the resin composition can be competitive. Here, the modified polyphenylene ether resin and the diamine will be explained in detail below.

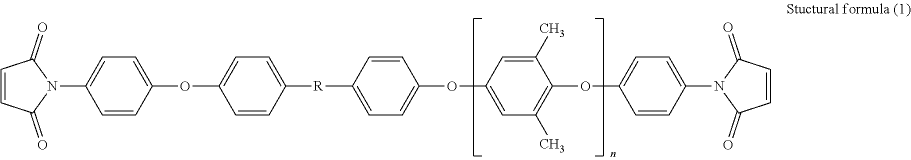

Further, among numerous resin systems, the disclosure clearly illustrates that polyimide systems can substantially improve multiple characteristics of the resin composition, such as glass transition temperature, coefficient of thermal expansion, peel strength, water absorption, heat resistance, dielectric constant and/or dielectric loss. Based on this, the resin composition of the disclosure clearly demonstrates that it has favorable effects in the application field of the polyimide system.

In some embodiments, the resin composition can be applied to circuit boards, wherein a dielectric constant of the circuit board made by the resin composition is 3.2 to 3.5, a dielectric loss is less than 0.0035, a glass transition temperature is greater than 280° C., a coefficient of thermal expansion is less than 15 ppm/° C., a peel strength is greater than 4 lb/in and a water absorption rate is less than 0.4%, so it can be a resin composition with low water absorption and low dielectric properties. For example, in the application field of 5G communication, in order to meet the needs of high-frequency transmission of circuit boards, low water absorption and low dielectric properties are required. The current polyimide system often has high water absorption and dielectric property problems, so the disclosure clearly demonstrates that the reactivity of modified polyphenylene ether resin and diamine can effectively reduce the water absorption and dielectric properties of the polyimide system. That is, the resin composition of the disclosure, which is applied to 5G communication, can have substantially improved technical efficiency, but the disclosure is not limited thereto.

### Diamine

In some embodiments, the diamine can be a primary amine compound having a diamine structure and can be selected from diamine compounds represented by the following General formula (A1) to General formula (A8):

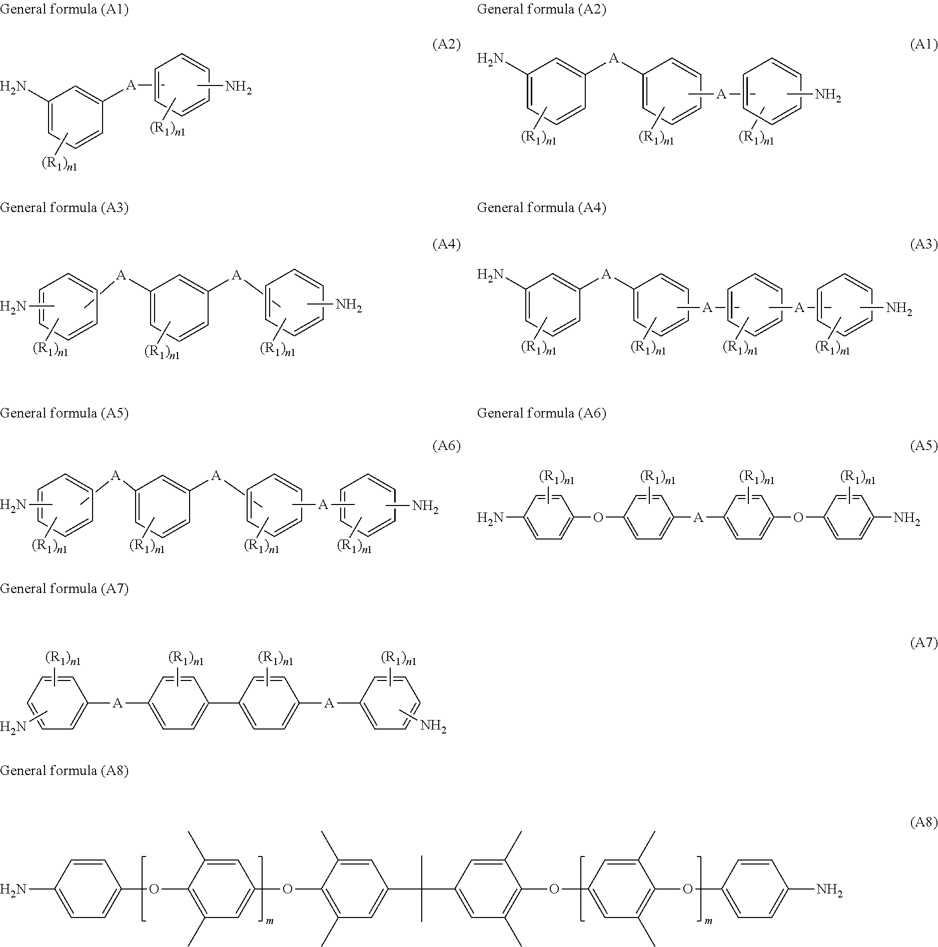

In the aforementioned General formula (A1) to General formula (A7), R₁ is independently selected from monovalent hydrocarbon groups or alkoxy groups with carbon numbers of 1 to 6; A is independently selected from divalent linking groups of —O—, —S—, —CO—, —SO—, —SO₂—, —COO—, —CH₂—, —C(CH₃)₂—, —NH— or —CONH—; n₁ is independently selected from integer of 0 to 4.

In aforementioned General formula (A3), those which overlap with General formula (A2) are excluded. In the aforementioned General formula (A5), those which overlap with General formula (A4) are excluded.

Diamines that can be represented by General formula (A1) are, for example, but not limited to: 3,3′-Diaminodiphenylmethane, 3,3′-Diaminodiphenylpropane, 3,3′-Diaminodiphenylsulfide, 3,3′-Diaminodiphenyl Diaminodiphenyl ether, 3,3′-diaminodiphenyl ether, 3,4′-diaminodiphenyl ether, 3,4′-diaminodiphenylmethane, 3,4′-diaminodiphenylmethane Diphenylpropane, 3,4′-diaminodiphenylsulfide, 3,3′-diaminobenzophenone, or (3,3′-diamino)diphenylamine.

Diamines that can be represented by General formula (A2) are, for example, but not limited to: 1,4-bis(3-aminophenoxy)benzene, 3-[4-(4-aminophenoxy)phenoxy]aniline or 3-[3-(4-aminophenoxy) phenoxy]aniline.

Diamines that can be represented by General formula (A3) are, for example, but not limited to: 1,3-bis(4-aminophenoxy)benzene (TPE-R), 1,3-bis(3-aminophenoxy)benzene (APB), 4,4′-[2-methyl-(1,3-phenylene)dioxy]bisaniline, 4,4′-[4-methyl Base-(1,3-phenylene)dioxy]bisaniline or 4,4′-[5-methyl-(1,3-phenylene)dioxy]bisaniline.

Diamines that can be represented by General formula (A4) are, for example, but not limited to: bis[4-(3-aminophenoxy)phenyl]methane, bis[4-(3-aminophenoxy)phenyl]propane, bis[4-(3-aminophenoxy)benzene base] ether, bis[4-(3-aminophenoxy)phenyl]pyridine, bis[4-(3-aminophenoxy)]benzophenone or bis[4,4′-(3-Aminophenoxy)]benzylaniline.

Diamines that can be represented by General formula (A5) are, for example, but not limited to: 4-[3-[4-(4-Aminophenoxy)phenoxy]phenoxy]aniline or 4,4′-[oxybis(3,1-phenoxy)]bisaniline.

Diamines that can be represented by General formula (A6) are, for example, but not limited to: 2,2-Bis[4-(4-aminophenoxy)phenyl]propane (BAPP), Bis[4-(4-aminophenoxy)phenyl]ether (BAPE), Bis[4-(4-aminophenoxy)phenyl]sulfone (BAPS) or Bis[4-(4-aminophenoxy)phenyl]ketone (BAPK).

Diamines that can be represented by General formula (A7) are, for example, but not limited to: Bis[4-(3-aminophenoxy)]biphenyl or bis[4-(4-aminophenoxy)]biphenyl.

In the aforementioned General formula (A8), m is an integer independently selected from 6 to 8.

In some embodiments, the compound with the structure of General formula (A8) can be called polyphenylene ether diamine (which can be abbreviated as: PPE-NH₂).

In some embodiments, the aforementioned primary amine compounds with diamine structure can be selected from the diamine compounds represented by General formula (A1) to General formula (A8), and can be selected from 4,4-diaminodicyclohexylmethane (PACM; CAS number: 1761-71-3), 1,3-bis(4-aminophenoxy)benzene (TPE-R; CAS number: 2479-46-1), 2,2-bis[4-(4-aminophenoxy)phenyl]propane (BAPP; CAS number: 13080-86-9) or a combination of the above.

In some embodiments, a weight ratio range of diamine is between 20 wt % and 60 wt % (such as 20 wt %, 25 wt %, 30 wt %, 40 wt %, 50 wt %, 60 wt % or any value within the above-mentioned 20 wt % to 60 wt %), based on a total weight of the resin in the resin composition, but the disclosure is not limited thereto.

### Modified Polyphenylene Ether Resin

A manufacturing method of the modified polyphenylene ether resin includes the following steps in sequence, it must be noted that the order of each step recited in the present embodiment and the actual mode of operation can be adjusted as required, and are not limited to the present embodiment.

First, a high molecular weight polyphenylene ether (PPE) resin material is provided, and the high molecular weight polyphenylene ether resin material has a first number average molecular weight (Mn), wherein the first number average molecular weight (Mn) of the high molecular weight polyphenylene ether resin material is not less than 18,000, and preferably not less than 20,000, but the disclosure is not limited thereto.

The high molecular weight polyphenylene ether resin material has the following chemical structure General formula (1-1), wherein n is an integer between 150 and 330 and preferably between 165 and 248.

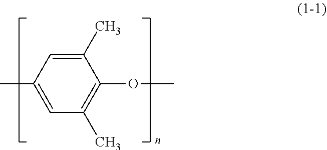

In some embodiments, the polyphenylene ether resin material may also be called polyphenylene oxide (PPO). The polyphenylene ether resin material has excellent insulation, acid and alkali resistance, excellent dielectric constant, and low dielectric loss. Therefore, the polyphenylene ether resin material has more excellent electrical properties than the epoxy resin material, and the polyphenylene ether resin material is more suitable for use as an insulating substrate material for a high-frequency printed circuit board, but the disclosure is not limited thereto.

After providing a high molecular weight polyphenylene ether resin material, then, implementing a cracking process, so that the high molecular weight polyphenylene ether resin material is cracked to form a low molecular weight polyphenylene ether resin material having a second number average molecular weight and modified by a bisphenol functional group (also referred to as a small molecule PPE with a phenolic terminal group). The second number average molecular weight is less than the above-mentioned first number average molecular weight (that is, the number average molecular weight of the polyphenylene ether resin material before cracking), wherein the second number average molecular weight (Mn) of the low molecular weight polyphenylene ether resin material is not greater than 12,000, and preferably not less than 10,000, but the disclosure is not limited thereto.

More specifically, the cracking process includes: using a bisphenol compound (phenolic material) and the high molecular weight polyphenylene ether resin material (that is, a high molecular weight PPE) with the first number average molecular weight for a reaction in the presence of a peroxide. As a result, the high molecular weight polyphenylene ether resin material is cracked to form the low molecular weight polyphenylene ether resin material having the second number average molecular weight, which is less than the first number average molecular weight. One side of the polymer chain of the low molecular weight polyphenylene ether resin material is modified with the phenolic functional group, its chemical structure is following General formula (1-2), wherein R represents a chemical group of a bisphenol compound located between two hydroxyphenyl functional groups thereof.

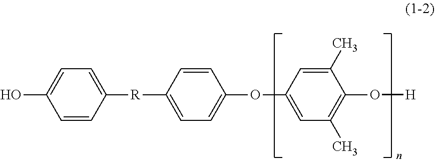

For example, as shown in the following Table 2, R can be, for example: direct bond, methylene, ethylene, isopropylidene, 1-methylpropyl, sulfone, or fluorene, wherein n is an integer between 3 and 25, and preferably between 10 and 18. In some embodiments, the number average molecular weight (Mn) of the low molecular weight polyphenylene ether resin material is usually between 500 g/mol and 5,000 g/mol, preferably between 1,000 g/mol and 3,000 g/mol, and particularly preferably between 1,500 g/mol and 2,500 g/mol. In addition, the weight average molecular weight (Mw) of the low molecular weight polyphenylene ether resin material is usually between 1,000 g/mol and 10,000 g/mol, preferably between 1,500 g/mol and 5,000 g/mol, and particularly preferably between 2,500 g/mol and 4,000 g/mol, but the disclosure is not limited thereto.

In some embodiments, the bisphenol compound is at least one selected from the material group consisting of 4,4′-bisphenol, bisphenol A, bisphenol B, bisphenol S, bisphenol fluorene, 4,4′-ethylene bisphenol, 4,4′-dihydroxy diphenol benzene, 3,5,3′,5′-tetramethyl-4,4′-dihydroxybiphenyl, and 2,2-bis(4-hydroxy-3,5-dimethylphenyl)propane. The types of the bisphenol compound are shown in Table 1.

TABLE 1

| Item | Bisphenol compound | CAS mumber |
|---|---|---|
| 1 | 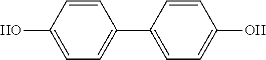 [SMILES: Oc1ccc(-c2ccc(O)cc2)cc1] | 92-88-6 (4,4′-bisphenol) |
| 2 | 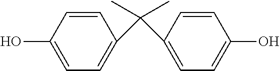 [SMILES: CC(C)(c1ccc(O)cc1)c1ccc(O)cc1] | 80-05-7 (bisphenol A) |
| 3 | 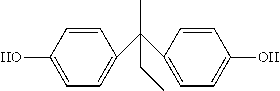 [SMILES: CCC(C)(c1ccc(O)cc1)c1ccc(O)cc1] | 77-40-7 (bisphenol B) |
| 4 | 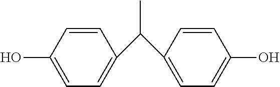 [SMILES: CC(c1ccc(O)cc1)c1ccc(O)cc1] | 2081-08-5 (4,4′-ethylene bisphenol) |
| 5 | 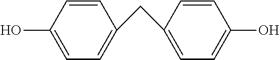 [SMILES: Oc1ccc(Cc2ccc(O)cc2)cc1] | 620-92-8 (4,4′-dihydroxy diphenol benzene) |
| 6 | 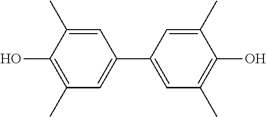 [SMILES: Cc1cc(-c2cc(C)c(O)c(C)c2)cc(C)c1O] | 2417-04-1 3,5,3′,5′-tetramethyl-4,4′-dihydroxybiphenyl) |
| 7 | 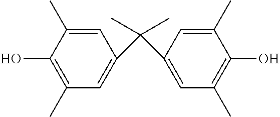 [SMILES: Cc1cc(C(C)(C)c2cc(C)c(O)c(C)c2)cc(C)c1O] | 5613-46-7 (2,2-bis(4-hydroxy-3,5-dimethylphenyl) Propane) |
| 8 | 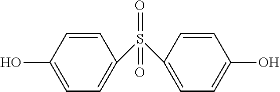 [SMILES: O=S(=O)(c1ccc(O)cc1)c1ccc(O)cc1] | 80-09-1 (bisphenol S) |
| 9 | 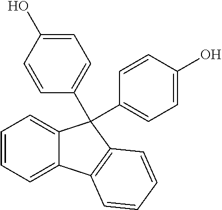 [SMILES: Oc1ccc(C2(c3ccc(O)cc3)c3ccccc3-c3ccccc32)cc1] | 3236-73-3 (bisphenol fluorine) |

Chemical groups of a bisphenol compound located between two hydroxyphenyl functional groups are shown in Table 2.

Table 2

| | | Chemical groups of a bisphenol compound |
|---|---|---|
| Item | Bisphenol compound | located between tro hydroxyphenyl functional groups |
| 1 | 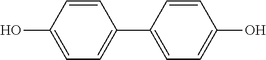 [SMILES: Oc1ccc(-c2ccc(O)cc2)cc1] | direct bond |
| 2 | 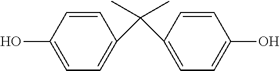 [SMILES: CC(C)(c1ccc(O)cc1)c1ccc(O)cc1] | isopropylidene |
| 3 | 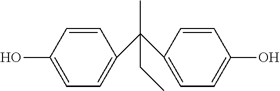 [SMILES: CCC(C)(c1ccc(O)cc1)c1ccc(O)cc1] | 1-methylpropyl (or, second butyl) |
| 4 | 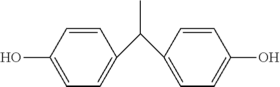 [SMILES: CC(c1ccc(O)cc1)c1ccc(O)cc1] | ethylene |
| 5 | 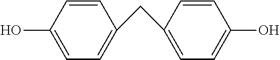 [SMILES: Oc1ccc(Cc2ccc(O)cc2)cc1] | methylene |
| 6 | 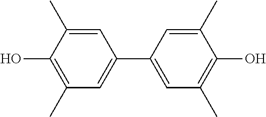 [SMILES: Cc1cc(-c2cc(C)c(O)c(C)c2)cc(C)c1O] | direct bond |
| 7 | 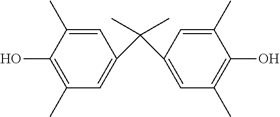 [SMILES: Cc1cc(C(C)(C)c2cc(C)c(O)c(C)c2)cc(C)c1O] | isopropylidene |
| 8 | 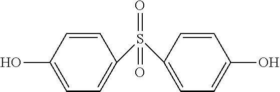 [SMILES: O=S(=O)(c1ccc(O)cc1)c1ccc(O)cc1] | sulfone |
| 9 | 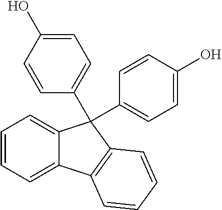 [SMILES: Oc1ccc(C2(c3ccc(O)cc3)c3ccccc3-c3ccccc32)cc1] | fluorene |

In some embodiments, the material type of the peroxide is at least one selected from the material group consisting of azobisisobutyronitrile, benzoyl peroxide, and dicumyl peroxide. The material types of the peroxide are shown in Table 3 below.

TABLE 3

| Item | Peroxide | CAS number |
|---|---|---|
| 1 | 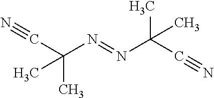 | 78-67-1 azobisisobutyronitrile |
| 2 | 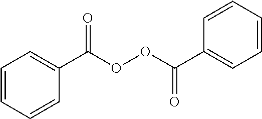 [SMILES: O=C(OOC(=O)c1ccccc1)c1ccccc1] | 94-36-0 (benzoyl peroxide) |
| 3 | 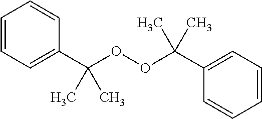 [SMILES: CC(C)(OOC(C)(C)c1ccccc1)c1ccccc1] | 80-43-3 (dicumyl peroxide) |

After implementing the cracking process, implementing a nitrification process, so that the low molecular weight polyphenylene ether resin material is subjected to nitration reaction, and further make two sides of the polymer chain of the low molecular weight polyphenylene ether resin material respectively modified with nitro functional groups (also known as terminal nitro PPE), which has the following chemical structure General formula (1-3).

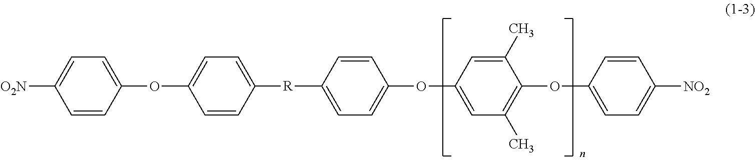

More specifically, the nitration process includes: a 4-halonitrobenzene material and a low molecular weight polyphenylene ether resin material which is cracked and modified with the bisphenol functional groups undergo a nitration reaction in an alkaline environment, so that the two ends of the polymer chain of the low molecular weight polyphenylene ether resin material are respectively modified with nitro functional groups. The nitration reaction is carried out with the 4-halonitrobenzene material and the low molecular weight polyphenylene ether resin material in an alkaline environment, and the end of the polymer chain of the low molecular weight polyphenylene ether resin material will form negatively charged oxygen ions. It is easy for the negatively charged oxygen ions to attack 4-halonitrobenzene, the halogen of 4-halonitrobenzene is removed, and the nitrobenzene functional group is further modified to the two ends of the polymer chain of the low molecular weight polyphenylene ether resin material. That is, the two ends of the polymer chain of the low molecular weight polyphenylene ether resin material can be respectively modified with nitro functional groups through the above reaction mechanism.

In some embodiments, the nitration process is to nitrate the polyphenylene ether resin material in an alkaline environment with a pH value between 8 and 14, preferably between 10 and 14, but the invention is not limited thereto.

In some embodiments, the chemical structure of the 4-halonitrobenzene material is general formula

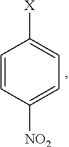

and the types of materials are shown in Table 4 below, wherein X is halogen, and preferably fluorine (F), chlorine (Cl), bromine (Br), or iodine (I).

TABLE 4

| Item | 4-halonitrobenzene | CAS number |
|---|---|---|
| 1 | 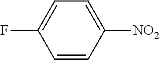 | 356-46-9 |
| 2 | 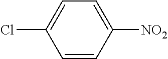 | 100-00-5 |
| 3 | 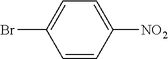 | 586-78-7 |
| 4 | 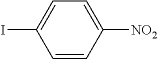 | 636-98-6 |

After implementing a nitration process, implementing a hydrogenation process, so that the low molecular weight polyphenylene ether resin material, wherein two ends of the polymer chain are respectively modified with nitro functional groups, undergoes a hydrogenation reaction, and is reduced to a low molecular weight polyphenylene ether resin material modified with amino functional groups at both ends of the polymer chain (amine-terminated PPE), and its chemical structure is as follows: General formula (1-4).

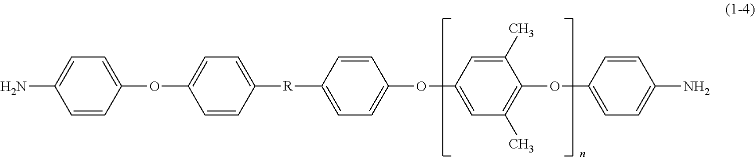

More specifically, the hydrogenation process includes: a hydrogenation solvent and the low molecular weight polyphenylene ether resin material (two ends of the polymer chain are respectively modified with nitro functional groups) are used for a hydrogenation reaction, wherein the material type of the hydrogenation solvent is at least one selected from the material group consisting of dimethylacetamide (DMAC, CAS number 127-19-5), tetrahydrofuran (TIF, CAS number 109-99-9), toluene (CAS No. 108-88-3), and isopropanol (CAS No. 67-63-0). In some embodiments, the use of dimethylacetamide as the hydrogenation solvent can make the hydrogenation process achieve excellent hydrogenation conversion (such as: greater than 99% hydrogenation conversion), but the present invention is not limited thereto. It is worth mentioning that the parameters controlling the hydrogenation conversion rate include: (1) solvent selection and the ratio of mixed solvents, (2) catalyst addition amount, (3) hydrogenation reaction time, (4) hydrogenation reaction temperature, and (5) hydrogenation reaction pressure. The material types of the hydrogenation solvent are shown in Table 5 below.

TABLE 5

| Item | Hydrogenation solvent | CAS number |
|---|---|---|
| 1 | 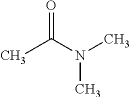 | 127-19-53 N,N-dimethylacetamide |
| 2 | 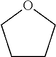 | 109-99-9 tetrahydrofuran |
| 3 | 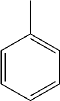 | 108-88-3 tetrahydrofuran |
| 4 | 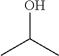 | 67-63-0 isopropanol |

After implementing a hydrogenation process, implementing a synthesis process, which includes: the low molecular weight polyphenylene ether resin material formed in the hydrogenation process, wherein the two ends of the polymer chain are respectively modified with amino functional groups (that is, PPE with terminal amino groups), and maleic anhydride are used for synthesis reaction to synthesize a modified polyphenylene ether resin, the chemical structure thereof is General formula (1-5).

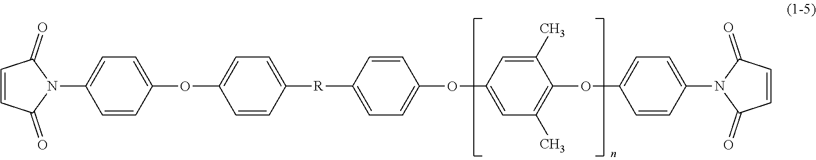

R represents a chemical group of a bisphenol compound located between two hydroxyphenyl functional groups thereof, and n is an integer ranging from 3 to 25, and preferably ranging from 10 to 18. The chemical structure of the maleic anhydride is as follows

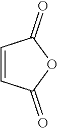

More specifically, in the synthesis process, the low molecular weight polyphenylene ether resin material, wherein the two ends of the polymer chain are respectively modified with amino functional groups (that is, PPE with terminal amino groups), is first combined with maleic anhydride and undergoes a ring-opening reaction, and the synthesis process further uses p-toluene-sulfonic acid as a dehydrating agent to perform a ring-closing reaction, and then synthesize the modified polyphenylene ether resin. It is worth mentioning that the two ends of the polymer chain are respectively modified with bismaleimide in the low molecular weight polyphenylene ether resin material through the above steps, its chemical structure also has polyphenylene ether main chain, and the terminal position of the polymer chain is modified into a reactive group with high heat resistance (ie, bismaleimide). Thus, the synthetic resin material has relatively low dielectric constant and dielectric loss. According to the above-mentioned series of material modification procedures, the high molecular weight polyphenylene ether resin material can be cracked into the low molecular weight polyphenylene ether resin material. The molecular structure of the low molecular weight polyphenylene ether resin material can be modified with bisphenols group, and the two ends of the polymer chain of the low molecular weight polyphenylene ether resin material are further modified with bismaleimide.

In some embodiments, a weight ratio range of the modified polyphenylene ether resin is less than or equal to 80 wt % (for example, 5 wt %, 10 wt %, 20 wt %, 40 wt %, 60 wt %, 80 wt % or any value within the above less than or equal to 80 wt %), based on the total weight of resin in resin composition, but the invention is not limited thereto.

In some embodiments, BMI resin is a polyphenylmethane maleimide resin (CAS number: 67784-74-1; BMI-2300 (Daiwa Chemical Industry (stock) system, trade name, Structural formula (A)), wherein the weight ratio range of polyphenylmethane maleimide resin is between 20 wt % and 60 wt % (such as 20 wt %, 25 wt %, 30 wt %, 40 wt %, 50 wt %, 60 wt % or any value within the abovementioned 20 wt % to 60 wt %), based on the total weight of resin in the resin composition. Therefore, the usage amount of polyphenylmethane maleimide resin can be reduced after using modified polyphenylene ether resin (by bismaleimide), and bis-(3-ethyl-5-methyl-4-maleimidephenyl)methane (CAS number: 105391-33-1; as BMI-70 (KI Chemical Company system, trade name, Structural formula (B))) can be not used.

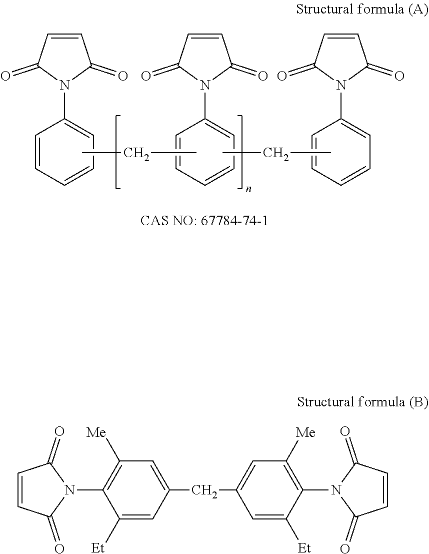

In some embodiments, the resin composition further includes a catalyst, a flame retardant, silica, a siloxane coupling agent or a combination thereof, wherein a usage amount of the catalyst is between 0.005 phr and 1 phr (such as 0.005 phr, 0.01 phr, 0.05 phr, 0.1 phr, 0.5 phr, 1 phr or any value within the above 0.005 phr to 1 phr), a usage amount of flame retardant is between 25 phr and 40 phr (such as 25 phr, 30 phr, 32 phr, 34 phr, 38 phr, 40 phr or any value within the above-mentioned 25 phr to 40 phr), a weight ratio range of silica is between 40 wt % and 70 wt % (such as 40 wt % %, 45 wt %, 50 wt %, 50 wt %, 60 wt %, 70 wt % or any value within the above 40 wt % to 70 wt %)), and a usage amount of the siloxane coupling agent is between 0.1 phr and 5 phr (for example, 0.1 phr, 0.5 phr, 1 phr, 2 phr, 3 phr, 5 phr or any value within the above 0.1 phr to 5 phr), but the present invention is not limited thereto. Here, the unit phr can be defined as the parts by weight of other materials per 100 parts by weight of resin in resin composition, and the weight ratio of silica is based on the weight of resin in resin composition plus the weight of flame retardant. The resins in the resin composition are, for example, diamine, modified polyphenylene ether resin and polyphenylmethane maleimide resin.

In some embodiments, the catalyst can be 2-ethyl 4-methylimidazole (2E4MZ: CAS: 931-36-2:

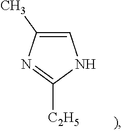

so that the diamine and the resin (such as modified polyphenylene ether resin and/or polyphenylmethane maleimide resin) are catalyzed during the thermal curing process to have better reactivity, but the present invention is not limited thereto.

In some embodiments, the flame retardant is a halogen-free flame retardant, and a specific example can be phosphorus-based flame retardants which can be selected from phosphate esters, such as: triphenyl phosphate (TPP), resorcinol diphosphate (RDP), bisphenol A di (Diphenyl) phosphate (BPAPP), bisphenol A bis(dimethyl) phosphate (BBC), resorcinol diphosphate (CR-733S), resorcinol-bis(di-2, 6-dimethylphenyl phosphate) (PX-200); can be selected from phosphazenes (phosphazene), such as: polybis(phenoxy)phosphazene (SPB-100); ammonium polyphosphates, melamine phosphate (MPP), melamine cyanurate; can be selected from more than one combination of DOPO flame retardants, such as DOPO (Structural formula (C)), DOPO-HQ (Structural formula (D)), double DOPO derived structures (Structural formula (E)), etc.; aluminum-containing hypophosphite lipids (Structural formula (F)).

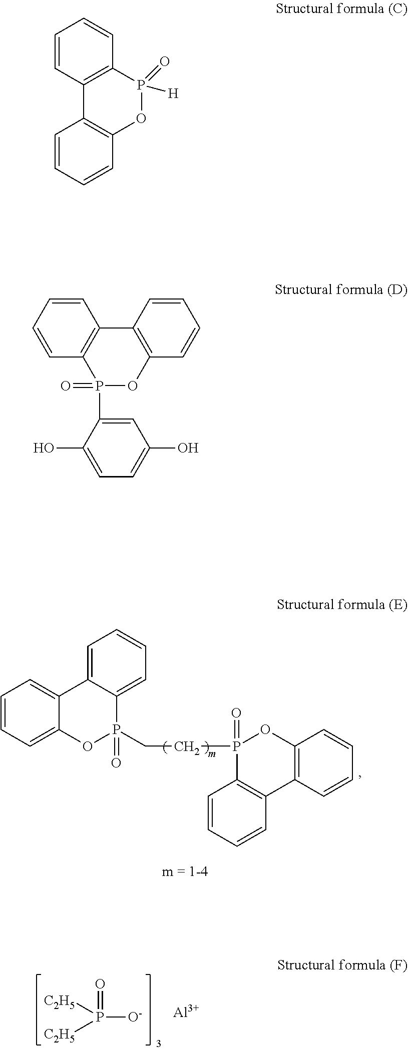

In some embodiments, the silica is a spherical silica and can preferably be prepared using a synthetic method to reduce electrical properties and maintain fluidity and glue filling, wherein the spherical silica has acrylic or vinyl surface modification, the purity is about 99.0% or more, and the average particle diameter D50 is about 2.0 microns (μm) to 3.0 μm, but the present invention is not limited thereto.

In some embodiments, the siloxane coupling agent may include, but is not limited to, siloxane compounds. In addition, according to the type of functional group, it can be divided into amino silane compounds, epoxy silane compounds, vinyl silane compounds, ester silane compounds, hydroxyl silane compounds, isocyanate silane compounds, methyl acryloxysilane compound and the acryloxysilane compound, which are used to enhance the compatibility and crosslinking degree of the glass fiber cloth and the powder in the circuit board, but the invention is not limited thereto.

It should be noted that the resin composition of the present invention can be processed into prepregs and copper clad substrates (CCL) according to actual design requirements, and the specific implementations listed above are not limitations of the present invention, as long as the resin composition included all belong to the protection scope of the present invention.

Now enumerate following Examples and Comparative Examples to clarify effect of the present invention, but the scope of the present invention is not limited to the scope of embodiment.

The copper foil substrates produced in Examples and Comparative Examples are evaluated by the following methods.

Glass transition temperature (° C.) is tested with a dynamic mechanical analyzer (DMA).

Water absorption rate (%): after the sample is heated in 120° C. and 2 atm pressure cooker for 120 minutes, calculate the amount of weight change before and after heating.

288° C. of solder-resistant heat resistance (seconds): the sample is immersed in a 288° C. solder furnace after being heated in the 120° C. and 2 atm pressure cooker for 120 minutes, and the time required for the delamination of the sample is recorded.

Dielectric constant Dk: test the dielectric constant Dk during frequency 10 GHz with dielectric analyzer HP Agilent E4991A.

Dielectric loss Df: test the dielectric loss Df at frequency 10 GHz with dielectric analyzer HP Agilent E4991A.

The coefficient of thermal expansion (CTE) is tested with a thermomechanical analyzer (TMA).

Copper foil peel strength (lb/in): test the peel strength between copper foil and circuit carrier.

### Examples 1-2, Comparative Example 1

The resin composition shown in Table 6 is mixed with methyl ethyl ketone to form the varnish of thermosetting resin composition. The above-mentioned varnish is impregnated with Nanya glass fiber cloth (Nanya plastic company, cloth kind model 1078LD) at normal temperature, and then after drying at 130° C. (impregnation machine) for a few minutes, a prepreg with a resin content of 70 wt % is obtained. Finally, four pieces of prepreg are stacked between two pieces of copper foil with a thickness of 35 μm, under 25 kg/cm² pressure and temperature 85° C., keep the constant temperature for 20 minutes, heat up to 210° C. at a heating rate of 3° C./min, and then keep the constant temperature for 120 minutes. Next, slowly cool to 130° C. to obtain a 0.59 mm thick copper foil substrate. Here, the modified polyphenylene ether resin in Table 6 is to dissolve the cracked small molecule PPE (Mn=1,600) in a solvent of dimethylacetamide, add potassium carbonate and tetrafluoronitrobenzene, and heat up to 140° C. After reacting for 8 hours, cool down to room temperature, filter to remove the solid, the solution is precipitated with methanol/water, and the precipitate is the product (PPE-NO₂); the product is then placed in the solvent dimethylacetamide, and carried out hydrogenation at 90° C. for 8 hours, that is, PPE-NH₂; the product is placed in toluene, maleic anhydride and p-toluenesulfonic acid are added, the temperature is raised to 120° C. to reflux, and the reaction is for 8 hours to generate the modified polyphenylene ether resin.

The physical properties of the copper foil substrate made by testing are shown in Table 6 in detail. After comparing the results of Examples 1-2 and Comparative Example 1 in Table 6, the following conclusions can be drawn: Compared with Comparative Example 1, Examples 1-2 can effectively improve its glass transition temperature, thermal expansion coefficient, peel strength, water absorption properties, heat resistance, dielectric constant and/or dielectric loss, etc.

TABLE 6

| | | | | Comparative |
|---|---|---|---|---|
| | | Example | | Example |
| | | 1 | 2 | 1 |
| Resin (100 | Diamine(4,4-Diaminodiphenylmethane, MDA) | 30 wt % | 30 wt % | 30 wt % |
| parts by | Modified polyphenylene ether resin | 20 wt % | 40 wt % | 0 |
| weight in | Polyphenylmethane maleimide resin (BMI- | 50 wt % | 30 wt % | 50 wt % |
| total) | 2300) | | | |
| | Bis-(3-ethyl-5-methyl-4- | 0 | 0 | 20 wt % |
| | maleimidophenyl)methane (BMI-70) | | | |
| Other | Flame retardant(CHIN YEE CHEMICAL | 30 phr | 30 phr | 30 phr |
| additives | INDUSTRIES CO., LTD., PQ60) | | | |
| (relative to | Silica | 60 wt % | 60 wt % | 60 wt % |
| 100 parts | Catalyst (2E4MZ) | 1 phr - | 1 phr | 1 phr |
| by weight | Siloxane coupling agent | 0.5 phr | 0.5 phr | 0.5 phr |
| of resin) | (Methacryloxysilane compound) | | | |

| | | | |
|---|---|---|---|
| B-stage curing temperature | 130° C. | 130° C. | 130° C. |
| Glass transition temperature (° C.) | 328° C. | 298° C. | 342° C. |
| Thermal expansion coefficient (XX) | 12 ppm/° C. | 12 ppm/° C. | 11 ppm/° C. |
| Peel strength | 4.89 lb/in | 5.62 lb/in | 3.48 1b/in |
| Water absorption (PCT ½ hour) | 0.28% | 0.21% | 0.55% |
| Heat resistance (PCT ½ hour) | Pass | Pass | Pass |
| Water absorption (PCT 2 hour) | 0.35% | 0.32% | 0.62% |
| Heat resistance (PCT 2 hour) | Pass | Pass | Pass |
| Dielectric constant (Dk)/Dissipation factor (Df) | 3.38/0.00351 | 3.35/0.00306 | 3.44/0.00428 |

(measurement frequency 10 GHz)

It should be noted that although the above-mentioned circuit board is used as an example, the application field of the polyimide system of the present invention is not limited to the field of circuit boards, and other fields, such as those with ordinary knowledge in the technical field to which the present invention belongs, can be equally applied to water-absorbing and heat-resistant coatings, etc., all belong to the protection scope of the present invention.

To sum up, in the resin composition based on the polyimide system of the disclosures, the diamine is used as a cross-linking agent to combine with the modified polyphenylene ether resin with a specific structural formula. As a result, a good reactivity is generated through a functional group interaction between diamine and aforementioned modified polyphenylene ether resin, which effectively improve its performances of glass transition temperature, thermal expansion coefficient, peel strength, water absorption, heat resistance, dielectric constant and/or dielectric loss, so the resin composition can be competitive.

Although the present disclosure has been disclosed above with the embodiments, it is not intended to limit the present disclosure. Anyone with ordinary knowledge in the technical field may make some changes and modifications without departing from the spirit and scope of the present disclosure. The scope of protection of the present disclosure should be defined by the scope of the appended patent application.

What is claimed is:

1. A resin composition, comprising:
diamine;
a BMI resin; and
a modified polyphenylene ether resin having a following structural formula: 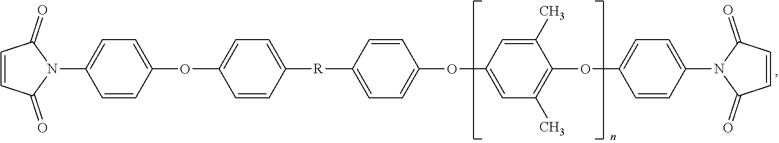
wherein R represents a chemical group of a bisphenol compound located between two hydroxyphenyl functional groups thereof, and n is an integer ranging from 3 to 25.

2. The resin composition of claim 1, wherein a weight ratio range of the diamine is 20 wt % to 60 wt %.

3. The resin composition of claim 1, wherein a weight ratio range of the modified polyphenylene ether resin is less than or equal to 80 wt %.

4. The resin composition of claim 1, wherein the BMI resin is a polyphenylmethane maleimide resin, and a weight ratio range of the polyphenylmethane maleimide resin is 20 wt % to 60 wt %.

5. The resin composition of claim 1, further includes a catalyst, a flame retardant, silica, a siloxane coupling agent or a combination thereof.

6. The resin composition of claim 5, wherein a usage amount of the catalyst is 0.005 phr to 1 phr.

7. The resin composition of claim 5, wherein a usage amount of the flame retardant is 25 phr to 40 phr.

8. The resin composition of claim 5, wherein a weight ratio range of silica is 40 wt % to 70 wt %.

9. The resin composition of claim 5, wherein a usage amount of the siloxane coupling agent is 0.1 phr to 5 phr.

10. The resin composition of claim 1, wherein a dielectric constant of a circuit board made by the resin composition is 3.2 to 3.5, a dielectric loss is less than 0.0035, a glass transition temperature is greater than 280° C., a thermal expansion coefficient is less than 15 ppm/° C., a peel strength is greater than 4 lb/in and a water absorption is less than 0.4%.
